(19) United States
(12) Patent Application Publication
(10) Pub. No.: US 2015/0142733 A1
(43) Pub. Date: May 21, 2015

(54) SYSTEM AND METHOD FOR EFFICIENT MANAGEMENT OF BIG DATA IN A DATABASE USING STREAMING TABLES

(71) Applicant: ORI SOFTWARE DEVELOPMENT LTD., Ramat Gan (IL)

(72) Inventor: Moshe SHADMON, Palo Alto, CA (US)

(21) Appl. No.: 14/546,450

(22) Filed: Nov. 18, 2014

Related U.S. Application Data
(60) Provisional application No. 61/962,796, filed on Nov. 18, 2013.

(51) Int. Cl. G06F 17/30

(52) U.S. Cl. CPC G06F 17/30289
USPC 707/609; 707/769; 707/741

(57) ABSTRACT

A system including a shared disk database cluster with multiple database nodes, the nodes configured to perform multiple processes, each database node configured to: insert data to a table, assign a unique location for the insert, the location representing a primary key and update the table without requiring contention between different processes.

### CROSS-REFERENCE TO RELATED APPLICATION

This nonprovisional application claims the benefit of U.S. Provisional Application No. 61/962,796, filed Nov. 18, 2013. The disclosure of the provisional application is hereby incorporated by reference herein in its entirety.

### BACKGROUND

1. Technical Field

The present disclosure relates to a database management system and method for efficient management of large shared data sets (i.e., shared “big data” sets).

2. Related Art

Database Management Systems (DBMS) are generally known. Some DBMS applications require fast insertion rates that may require millions of inserts per second or more. These inserts may generate petabytes of data that are complicated to manage and query. For example, a call center for a telecommunications company, which: (i) records every phone call, and (ii) satisfies queries by caller identification (ID) or phone number, may need a DBMS to support a high insertion rate (e.g., a rate of millions of events per second) as well as a support for queries that evaluate data. Another example is a DBMS that: (i) logs event data (e.g., events generated by servers and devices in a server farm) including device information and server information tied to the corresponding event, and (ii) queries the logged event data by device, server and/or type of event.

In addition, DBMS applications may need to support Business Intelligence (BI) functionality. BI functionality may include queries over data to find trends or aggregates based on recorded information. BI queries may specify a time interval and a behavior to be measured. For example, a user may query the database to find the phone usage for each type of phone plan offered by the telecommunications provider in the last six months.

U.S. Patent Publication No. 2012/0310881 (“Shadmon,” entitled: “EFFICIENT DISTRIBUTED LOCK MANAGER”), which is herein incorporated by reference, demonstrates processes for managing shared data with a cluster of servers. Shadmon shows that rather than managing data with a single database instance, a cluster of servers may efficiently manage the data and efficiently synchronize processes among database nodes that do not share memory.

A shared data approach (e.g., Shadmon's shared data approach) may have two tiers that facilitate database processing/management—a storage tier and a database tier. In the storage tier, the data may be partitioned and distributed to multiple storage nodes, where: (i) each node of the storage tier manages a portion of the data, and (ii) the collection of storage nodes of the storage tier may manage the entire collection of data. Like a Redundant Array of Independent Disks (RAID), which supports the Input/Output operations (i.e., IOs or I/O operations) by the multiple RAID disk drives (where each disk manages a subset of data), the storage tier may support the IOs by multiple storage nodes, and each storage node may manage a subset (portion) of data. In this approach, when a database node needs to update or query the data, it may interact with the specific storage node that maintains the needed data. A storage node, in this architecture, may be a physical or virtual machine with an attached or remote physical storage device, which executes software that satisfies (I/O) requests.

The database tier may have multiple database nodes and as the data is shared, the multiple database nodes may query or update the entire collection of data regardless of the storage node that manages the data. The cluster manager described in Shadmon synchronizes all the updates and queries of the different database nodes and, thus, the users only see a single and consistent view of the data.

One of the benefits of the shared data approach is the ability to manage large data sets efficiently (e.g., millions of phone call entries from a mobile phone of a call center of a telecommunications company). For example, in this approach, a cluster processes the data by a collection of database and storage nodes (or servers) that offer a significant amount of resources (e.g., processors (or central processing units (CPUs) and memory (e.g., RAM, ROM, hard disks)). In contrast, a shared nothing approach may only allow for data processing on a single database instance. In the shared data approach, scaling the cluster may be transparent to the applications. To scale, a user may add one or more database or storage instances, and, under the shared data approach, there is no need to partition or shard the data.

### SUMMARY

In order to manage (insert, update delete and query) large data sets, Shadmon demonstrates systems and methods to reduce contentions between different processes in the cluster. However, in the processing of data in the database of conventional shared data DBMS, some processes may inherently generate contention. For example, as multiple processes use the same index structure at the same time, they may need to be synchronized and resolve conflicting operations.

For example, in an index using a B-tree structure, multiple processes may need to update the same index block at the same time, thus, creating contention or competition for the same index block. These processes may compete to get a lock on the same index block or table, which would allow (grant permission for) an update of the same index block or table. The winning process or thread (of the competition) may update the index block while the other processes wait for the winning thread to finish. This competition or contention slows the overall throughput of the database.

Another example of contention is when a process is updating a block of an index, while, at the same time, a different process is interested in reading the block to find a particular key.

A conventional process using the B-tree index not only may generate contention, but also requires CPU usages that negatively impact the overall performance of the DBMS. For example, in the index update process, several index blocks may need to be retrieved and analyzed. The number of machine instructions that need to be executed in order to complete the update process may have an additional negative impact on the overall performance of the DBMS.

In a cluster environment, the same one or more index blocks (or the same one or more tables) may be shared among different processes in different database nodes or servers. If a particular same index block or table is updated or considered by a particular database node/server, but also needs to be considered or updated on a different database node or server, the block may need to be transferred from the particular database node or server to the different database node or server. Further, when a particular block is considered on a particular database node, but needs to be updated on a different node, the processes by the two nodes may need to be synchronized. In addition, if the index is large or “big” (e.g., does not fit to the local cache tier of a database node or server), in order to consider or update a particular block, the block may need to be retrieved from the storage tier by an I/O operation.

For an application such as a call center that may require millions of inserts per second and needs to satisfy BI queries over huge or large amounts of data (e.g., “big data”), there is a need in the art for additional DBMS mechanisms that would make the DBMS processes more efficient.

### BRIEF DESCRIPTION OF THE DRAWINGS

Exemplary embodiments will be described with reference to the following drawings.

FIG. 1 shows a shared disk database management system 100 (a clustered, shared disk DBMS) in accordance with an exemplary embodiment of the present disclosure. Shared disk DBMS 100 may include a database tier 101, which includes multiple DBMS nodes 101A-101C, and a storage tier 102, which includes multiple storage nodes 102A-102D. The database nodes 101A-101C and storage nodes 102A-102D may be connected by network 104 and managed by distributed lock manager (DLM) 103.

FIG. 2 shows an index structure based on a linked list 200 in accordance with a first sub-embodiment of FIG. 1. Linked list 200 connects rows that share the same key value. The anchor of linked list 200 may be from parent table 210 where entries in parent table 210 represent the key values (e.g., phone numbers) and the list connects rows with the same key.

FIG. 3 shows a local index 310 in accordance with a second sub-embodiment of FIG. 1. In particular, in this embodiment, local index 310 may be used on one of storage nodes 102A-102D. An entry in local index 310 may represents a key value (e.g., a time value, a time-date value). An entry in local index 310 may be connected to a row with a first occurrence of a key value in a data file 320.

### DETAILED DESCRIPTION

### Glossary of Terms

For clarity of explanation, there follows a glossary of terms used throughout the description and claims. Some of the terms are conventional and others have been coined.

A Database is an organized collection of data.

Database Management System or Systems (DBMS) are computer software applications that interact with a user, other applications and the dataset itself to capture and/or analyze data. For example, database and DBMS are explained: (i) by Hector Garcia-Molina, Jeffrey D. Ullman, Jennifer Widom in “Database Systems: The Complete Book, Second Edition,” (ii) by C. J. Date in “An Introduction To Database Systems, Volume 1, Fourth Edition,” and (iii) Wikipedia's online definition for “Database.”

A Database Node or Database Server is a virtual or physical machine. The database node or server may run/execute DBMS software. In the following description, the terms node and server are used interchangeably to refer to a database node or server. Non-limiting examples of DBMS software are: (i) Oracle database software, (ii) IBM DB2 software, and MySQL software. A database node may provide management of data such that users are provided with the methods and tools (among others) to update and query the data. For example, a database node, executing database software (e.g., Oracle database software) such that data manipulation requests (e.g., Insert, Update, Delete and Select) issued by users may trigger processes that update and query data. Further, a database node may have a local cache. The local cache may be used for efficient processing of frequently used data. A database node on a physical or virtual machine may provide database services. Users or applications may send requests to the database node to manipulate data. As another example, a physical or virtual machine (database node) executing an instance of MySQL server software may have a local cache. The local cache may be a memory area in the database node that maintains copies of frequently used data. Examples of frequently used data are particular rows of a table or particular blocks that contain data (or rows) that are frequently used.

A Storage Node is a virtual or physical machine executing software to manage input/output operations (IOs, I/O or I/O operations). A storage node receives one or more requests to manage data via IO requests (e.g., requests for reads or writes of data), executes a request, and, if needed, replies to satisfy the request. However, a storage node and and may satisfy many other requests (e.g., requests to scan files or portion of files and search for data that satisfy particular conditions). The storage node may, for example, write the data to some form of persistent storage such as a disk or solid state. Each storage node may have a local cache, which may be used for efficient processing of frequently used data.

An example of a storage node is a physical or virtual machine that provides data storage services. A storage node may satisfy I/O requests of database nodes. The transfer of the requests (between the storage node and database nodes) and the reply to the requests may be performed over a network.

A Cluster (or a Database Cluster or a Clustered Database) is formed of multiple database nodes that provide processing or management of data. The nodes of the cluster may be connected via a network and provide management of shared data.

Shared Data is data that is accessible to multiple database nodes. For example, in a shared data architecture, if data is updated or added by a particular database node, it is available to different database nodes (in the cluster) for update and query. A database cluster having a shared data architecture may provide a consistent view of the data (i.e., the database cluster is capable of providing the ACID properties (atomicity, consistency, isolation and durability) with the shared data. In the present disclosure, the terms shared data and shared disk are used interchangeably.

A Relational Database is a database that conforms to a relational model theory. The type of software used in a relational database may be called a relational database management system (RDBMS) or RDBMS software. In a relational database, data is logically assigned to tables and organized as rows within the tables, but the physical implementations may be different. As one example, rows may be physically stored within blocks of files. Some of the resources of the database may be indices, which may be organized in blocks of files, but are not part of the relational model theory. Some of the examples below use the logical organization of rows within tables or use some physical organization such as rows within blocks. However, the processes of the disclosure are not bound to a particular logical or physical organization.

An Attribute is a feature or characteristic of data. For example, an attribute may be represented as columns in a relational database. For example, a record representing a person may have an attribute “age” that is stored in a column representing an age of a person. Each column of a relational database may represent an attribute.

A Column, in the relational database context, represents attributes for particular rows in a relation. For example, a single row might contain a complete mailing address entry. The mailing address row may have four columns (attributes): street address, city, state, and zip code.

A Hidden Column is a column in a row that is not visible to a user and/or a user application. A hidden column is used by a database system (e.g., DBMS, RDBMS) for internal operations. For example, a hidden column may be a column that includes a link to a different row in the database. The link maintained in the hidden column may be part of a linked list that connects multiple rows in the database.

A Record is a single entry in a database. A record may also be referred to as a tuple or row in a relational database.

A Relation is used to organize data into a table consisting of logical rows and columns. Each logical row may represent an entry in the table or relation. Each logical column may represent an attribute of the logical row entries. A relation is frequently referred to as a table.

A Relational Database is a database that consists of one or more relations or tables.

A Database Administrator is a person (or persons) responsible for optimizing and maintaining a particular database or DBMS/RDBMS.

A Database Schema is an organization of data in a database. In a relational database example, all new data that comes into the database must be consistent with the schema. In this example, the database administrator may be required to change the schema (or reject the new data).

An Index is additional information about a database that is used to reduce the time required to find specific data in a database or add data to the database. For example, an index may provide access to particular rows based on a particular column or columns.

A Query is a search (query) for information in a database.

A Range Query is a search (query) for a range of data values. For example, a range query may be a search for: “all employees aged 25 to 40.”

Input/Output operations (IOs or I/O or I/O operations) are operations that facilitate communication between an information processing system and a human or other physical device. For example, a read from a physical device (e.g., a fixed disk (hard drive)) is an input operation. IOs may take a significant amount of time compared to memory operations, for example, they may take hundreds and even thousands of times longer or more. In the context of the disclosure, I/O also refers to the process of retrieving data from storage nodes or updating data on the storage node (output operations) or other forms of manipulating data on the storage node. An I/O process may include one or more messages over the network between a database node and a storage node.

A Proxy is a server (a computer system or an application) that acts as an intermediary for requests from clients seeking resources from other servers. See Wikipedia online definition of “Proxy Server.”

A Block Read is a read on a fixed sized chunk (a block) of information. A block read is implied to be an I/O, if the block is not in memory.

A Lock Manager is a manager that: (i) receives lock requests from different processes or threads, (ii) analyzes the lock requests, and (iii) manages the lock requests so that the integrity of data is maintained. For example, a lock manager may issue particular locks, without explicit lock requests, when it determines that a particular process or a particular node is interested in the particular lock.

A Local Lock Manager (LLM) is a lock manager that analyzes and manages the lock requests of different threads (or processes) by utilizing a shared memory space. An LLM and the requesting threads (or processes) may exist within the same node.

For more information, a discussion on locking is available by Hector Garcia-Molina, Jeffrey D. Ullman, Jennifer Widom in “Database Systems: The Complete Book, Second Edition,” at “Chapter 18, Concurrency Control, Section 18.4: Locking Systems with Several Lock Modes,” pages 905-913.

A Distributed Lock Manager (DLM) is a lock manager that analyzes and manage lock requests of different threads (or processes) of different nodes. A DLM and the different threads may communicate by sending messages over a network. The DLM may manage a cluster of nodes.

The management by a LLM and/or a DLM (together with other processes) maintains the integrity of the data. The LLM and/or DLM may maintain compliance of the database to the ACID set of rules.

ACID (atomicity, consistency, isolation, durability) Properties or Rules are a set of properties or rules that guarantee that database transactions are processed reliably.

A DLM may operate by monitoring processes in different nodes. The DLM, in this example: (i) analyzes lock requests that are issued from different processes (or nodes), (ii) provides grants to non-conflicting requests (e.g., multiple requests to read the same data at the same time), and (iii) sets an order among conflicting requests. For example, a write lock may be provided to process A by a DLM, and, thus, a grant (for a read or write request) for process B may be delayed by the DLM until the lock of process A is released.

SQL or Structured Query Language is a programming language designed for managing data in an RDBMS. SQL was one of the first commercial languages for Edgar F. Codd's relational model, as described in: (i) his influential 1970 paper, “A Relational Model of Data for Large Shared Data Banks,” and (ii) Wikipedia's online definition for “SQL.” Eventually, SQL became the most widely used database language. SQL is used also as a Data Manipulation Language (DML), which is a family of syntax elements similar to a computer programming language used for inserting, deleting and updating data in a database.

A Database Engine or Storage Engine is the underlying software component that a DBMS uses to create, read, update and/or delete (CRUD) data from a database. Most DBMS include their own Application Programming Interface (API) that allows a user to interact with their underlying database or storage engine without going through a user interface of the DBMS.

Many of the modern DBMS support multiple database engines within the same database. For example, MySQL may support InnoDB, MyISAM, and/or other storage engines.

A B-tree is a tree structure that can be used as an index in a database. It may be useful for exact match and range queries. B-trees may frequently require multiple block reads to access a single record. More information on B-trees can be found on pages 473-479 of “The Art of Computer Programming,” Volume 3, by Donald Knuth (® 1973, Addison-Wesley). A B-tree or one of its variants is widely used to index data in DBMS.

A Hash Table or Hash Index is a structure that can be used as an index in a database. A hash table/index may be useful for exact match queries, but it may not be useful for range queries. Hash tables generally require one block read to access a single record. More information on hash tables may be found on, for example, pages 473-479 of “The Art of Computer Programming,” Volume 3, by Donald Knuth (® 1973, Addison-Wesley).

A Linked List is a data structure linking or connecting a group of objects. For example, a process may consider an object of a linked list to be able to identify the next object on the linked list using a reference (a link) to a next object in the sequence. In this example, given the first object, using the linked list, all objects of the list can be identified.

A Unique Key is a column or columns that are declared to uniquely identify a row or entry in a table. For example, in a customer table containing customer information, a column representing a customer ID may be declared as a unique key and the database will enforce a single row instance for every key value. Most database systems maintain an index that efficiently locates the row by the unique key. One of the unique keys may be designated as the primary key.

A Non-Unique Key is a column or columns that are declared to identify a row or rows in a table, but without a requirement of uniqueness. For example, in a customer table that contains customer's information, the column representing the customer type may be declared as a non-unique key and the database may contain multiple rows with the same key value. Most database systems maintain an index that may efficiently locate rows by a non-unique key value.

A Lock Taken (process) is a process where a lock over a resource is taken. A lock taken may be a result of a process determining that there is no conflicting usage of the resource. The lock may be taken using an asynchronous message (e.g., the asynchronous lock taken message detailed in Shadmon).

Contention refers to a state of dependency between two or more processes. For example, a state of contention may result in a process being set in a wait state. The wait state may be resolved when a different process completes an operation or, in some cases, the wait state is resolved when the process in wait determines to terminate the operation.

A Process is an execution of computer instructions to execute a particular task. In a particular example, a process is executed by a particular thread.

### DETAILED DESCRIPTION OF THE EXEMPLARY EMBODIMENTS

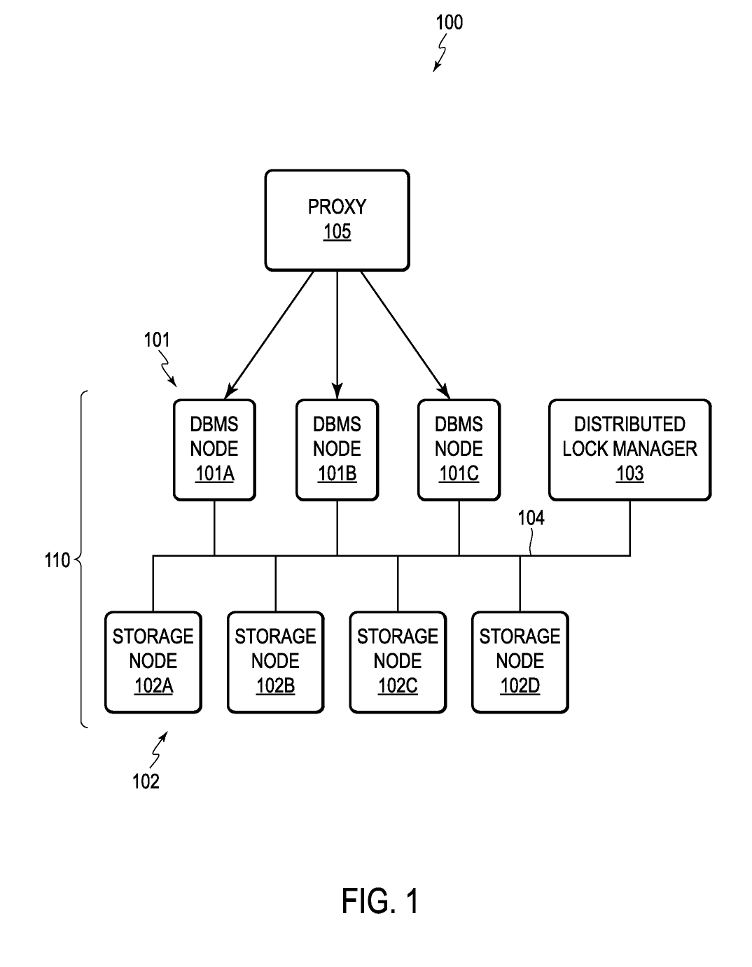

FIG. 1 shows a shared disk database management system 100 (a shared DBMS) in accordance with an exemplary embodiment of the present disclosure. Shared disk DBMS 100 includes a cluster 110 including: (i) a database tier 101, which includes multiple DBMS nodes 101A-101C, and (ii) a storage tier 102, which includes multiple storage nodes 102A-102D. The nodes in the cluster 110 (nodes 101A-101C and storage nodes 102A-102D) may be connected by network 104 to each other and connected to and managed by distributed lock manager (DLM) 103.

DLM 103 may synchronize the processes in the cluster 110. Cluster 110 may provide database functionality such as the functionality described in Shadmon. The network is further connected to a proxy 105. Proxy 105 may receive DML requests from applications or users (not shown), and partition these requests among the database nodes 101A-101C. In one example, these requests are SQL statements such as Insert

Insert, Update, Delete and Select.

Cluster 110 manages shared data, which is partitioned among the storage nodes 102A-102D. Every database node 101A-101C may be capable of updating or querying the entire data set of shared data. DLM 103 may resolve conflicts among processes of cluster 110. For example, if different processes in different database nodes are interested in updating the same data of the shared data at the same time, the DLM will evaluate the lock requests for the data and lock states being held over the same data to determine which process is granted permission to update (i.e., allowed to update). When a lock by a process is released, DLM 103 may grant a lock to a next process. Each database node 1A-1C has a Local Lock Manager (LLM). When processes within the same node compete over resources, the LLM will synchronize the operations of the different processes.

DLM 103 and the LLM of each database node 101A-101C may operate such that different users querying the database cluster 110 will receive a consistent view of the data regardless of the database node that processes the data. An advantage of managing the data by multiple database and storage nodes is that more resources (e.g., memory, CPU, disk drives) are available to support the user requests to manipulate the data.

In a particular example, the clustered DBMS 110 may be used to manage a call center. In the call center example, the database may manage several tables where one of the tables is an event table and each row in the event table represents a phone call. Therefore, each row in the event table may have a phone number originating the call (i.e., source phone number), the phone number receiving the call (i.e., destination phone number), the starting time of the call, the duration of the call and/or additional information as needed by the call center. In addition, the row may contain a column that uniquely identifies the row (e.g., an Event ID), which may be designated as the primary key.

When a database node 101A-101C processes a query, and, a key value is available, the node may use an index that supports the key to retrieve rows that satisfy the query. Alternatively, if a key is not available, the node may trigger a scan of the data in the table to find the row or rows that satisfy the query.

For example, if the event table of the call center database is indexed by phone number, this index may be used to retrieve the rows that have originated by a particular phone number. However, if the query is to find all the rows with a duration longer than three hours, and there is no index by duration, the database would issue a scan over the table rows to find the rows representing these calls (e.g., the rows with a duration over three hours).

As the database may be managing many DLM operations, multiple processes among the nodes 101A-101C in the cluster 110 are competing over many resources. In particular, adding data to the database creates contention or competition between processes within the same node and of different nodes over database resources. For example, when an insert process adds a row to an event table, several indexes need to be updated. As indexes are updated, the processes are competing over the locks that are required for the updates. To complete an update of, for example, a B-tree index, the updating process may need to retrieve non-leaf blocks of the index with read locks and update a leaf block with a write lock. If these locks are not compatible with existing locks over the needed resources, the updating process may need to wait for lock grants. In addition, the index update process may require reading and analyzing multiple index blocks and writes (IOs) of the updated block or blocks. These processes, which may involve I/O operations and may require substantial computing resources (e.g., CPU and memory usage), may negatively impact the overall performance of the database system. Accordingly, one purpose of the disclosure is to provide indexing systems and methods that minimize contention between processes and allow data to be added to a database, so that indexing and querying the data may be performed efficiently.

When new data is added to a table in a database, the data may be stored on a physical file and some indexes may be updated. In a relational database, the data is organized in rows and the rows are assigned to a table. Each row in a table may be logically (or sometimes physically) partitioned into one or more columns. Further, the database administrator may define one or more unique and non-unique keys over the one or more columns. If the table is defined with keys, these keys may be updated during the insert and delete processes (and sometimes during an update process).

The systems and methods of the disclosure may consider some of the tables of the database to be streaming tables. The primary key of a streaming table is indexed by a hash index such that the key value is mapped to a physical location.

Alternatively, the primary key is the physical location of the row in the table. In the example of the call center, the Event ID may be assigned a unique value that designates (or can be hashed to) the physical location of the row. The Event ID may be the location of the row in the file, or a value representing a block ID in a file and the location of the row in the block. In cluster 110 with multiple storage nodes 102A-102D, the primary key value may also be a value that identifies the storage node of the multiple storage nodes that contains the row. For example, to uniquely identify a row in a regular (non-clustered) database, it may be sufficient to identify the offset of the row in a file that contains the rows of a table. For example, the (hexadecimal) value 0x2345 may represent an offset in a file where the particular row exists. Therefore, a query for a particular row from a particular table with the ID 0x2345 would locate the particular row of the table. In a clustered database, as the data of each table may be available on all the storage nodes, this ID may be extended to include the ID of the storage node. For example, storage nodes 102A-102D of FIG. 1 may be identified by the numbers 0x01 to 0x04, respectively, and, therefore, to locate a row, the ID of the row is extended to include the ID of the storage node. Therefore, assuming that a particular row is placed on storage node 102B of FIG. 1 (storage node ID is 0x02), and, in offset 0x2345 of the file containing the data of the particular table, the ID of the row is extended to include the storage ID and becomes 0x234502. A search by the row with ID 0x234502 would be able to direct the search to node 102B (ID 0x2) and file location 0x2345. In this embodiment, updating the primary key is fast, because the key value is mapped to a physical location, and the row is written to the location indicated by the key. This process or method eliminates or minimizes contention between processes as each process uses different file locations or different files. In one embodiment of the disclosure, each process may be allocated with pre-defined unique locations for inserted data (new data). This embodiment is faster than tree based indexes (such as B-tree) where the update of the index may involve I/O operations of index blocks, and analyzing the index structure to locate the block to complete the update (I/O).

According to a process in a particular example of the database cluster 110, multiple processes are inserting new data. Each process may be assigned unique locations for the inserts, the primary key value may be mapped to the physical location, and as the processes are using the lock taken process to lock the required resources, the multiple processes may update the primary key concurrently. Thus, there is no or little contention between the different processes. As these processes may organize the inserted data in data blocks, which are uniquely assigned to each process, the processes may lock the data blocks and the rows with an asynchronous lock taken (ALT) message or process. The ALT message or process is a mechanism, in a clustered database, to lock a resource based on knowledge (e.g., information that the resource is a new resource or information from a previous lock grant request) that no other process is currently locking the resource and therefore, the ALT message or process is sent or performed by the process that needs the lock, without the need for evaluation of the lock state of the other processes over the resource. An example of a lock taken mechanism is detailed in Shadmon.

In a cluster with multiple database nodes, multiple processes on each node insert new data rows and index the data concurrently. The new rows are placed in data blocks, the data blocks being pre-allocated for each process. Therefore, there is no or little contention between the executing processes during the insertion process or processes. The executing processes can lock the required resources (e.g., data blocks) and insert the rows by using the ALT message or process.

The next phase is updating the non-primary keys. To index a non-primary key, the non-primary key is indexed by a new index structure. The new index structure may include an object representing a key value and a link from the object to an indexed row. These objects are used as anchors to the rows in the indexed table. If the key is not unique, the indexed row may include a hidden column that includes a link to the previously indexed row. The set of links originating from the object representing the indexed key is a linked list connecting rows with the same key value. If the key is unique, the list includes a single link from the object representing the key to the indexed row and the indexed row does not need to include a hidden column. The process of indexing the non-primary key is called secondary indexing.

The set of new objects that are used as anchors to the rows in the indexed table can be managed by a different table whereas every row in the table represents a key value and a column in a row of the table is a link to an indexed row. This table can be considered as a parent table to the table that is being indexed. The indexed table can be considered as the child table.

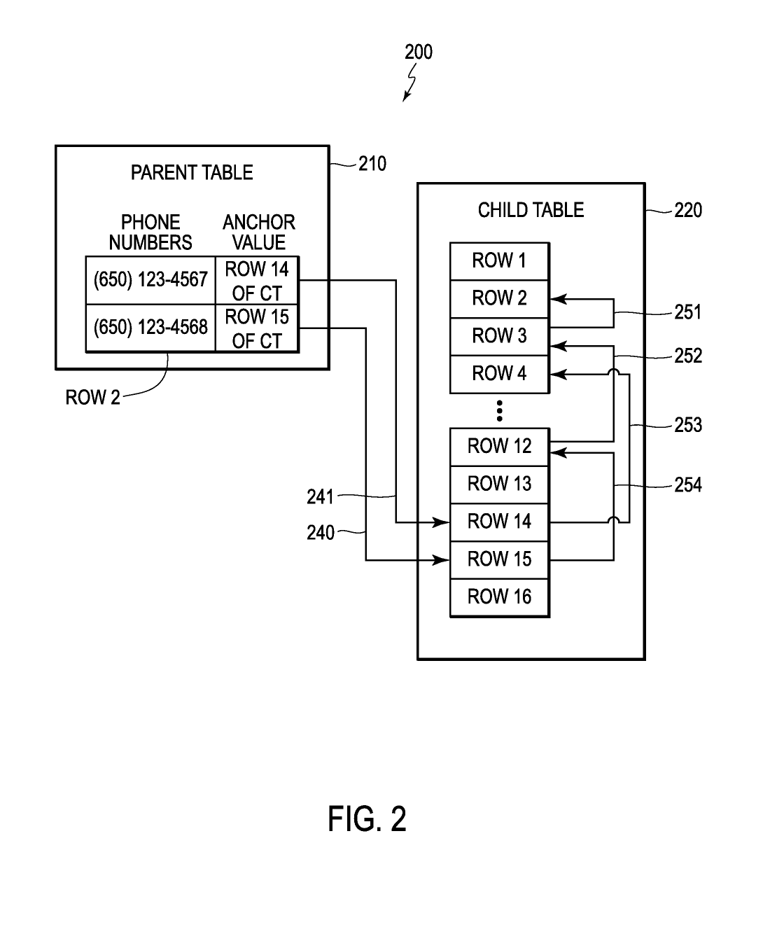

FIG. 2 shows an implementation of a linked list structure 200, which includes a parent table 210 and a child table 220. In the exemplary embodiment, child table 220 is an event table, for example, an event table of a shared DBMS of a call center of a telecommunications company. The clustered DBMS of the call center, in one embodiment, is the clustered DBMS 110 of FIG. 1. Further, child table 220 may be indexed by the phone number originating the call. The rows of the child table 220 may represent phone calls and each row may contain information about the call (e.g., the phone number that originated the call). A primary key of child table 220 may be a column that maps to a physical location in a file of a row of child table 220. For example, the primary key of row 12 of child table 220 is 12, which uniquely identifies the row 12 of child table 220 and represents the location of row 12 of child table 220 in the file (and ignoring the ID of the storage node. In practice, with multiple storage nodes, this ID would be extended to include the storage node ID and be 0x0c03 for row 12 (0x0c) assuming storage node 3). When rows are added, non-primary keys are updated as well. For example, a non-primary key may be a column representing a phone number. The index process, via the non-primary key, updates the parent table 210 such that a column in the row representing the phone number is updated with a link to the row in the child table 220. In the embodiment of FIG. 2, row 2 of table 210 is updated with link 240 to connect to row 15 of child table 220. In one embodiment, as child table 220 maintains additional rows with the same non-primary key value (e.g., the same phone number), a hidden column in each row of child table 220 maintains a link to a different row with the same key value: Row 15 maintains a hidden column with a link to Row 12, Row 12 maintains a hidden column with a link to Row 3, and Row 3 maintains a hidden column with a link to Row 2. This linked list represents rows that share the same phone number. The anchor for this linked list is Row 2 of the parent table 210 representing the phone number (650) 123-4568.

A foreign key may be a non-primary key in a table, but may be a primary key in a different table. For example, in the FIG. 2 embodiment and call center example, the phone number may be considered as a foreign key in the child table 220, but the same phone number may be the primary key in the parent table 210.

In the above embodiment, adding one or more new rows to the event or child table 220 may be performed by one or more of the following processes:
1. To add a new row to the Child Table 220, a new primary key value is provided to the new row of child table 220 by the updating process.
2. The primary key being mapped to a physical storage node and a location of a file or disk that contains the row.
3. A foreign key value (e.g., phone number) may be retrieved from the new row of child table 220.
4. A hash value of the foreign key may be mapped to a row in parent table 210.
5. An existing link value (or anchor value) of the row in parent table 210 may be retrieved.
6. The link value in the row of parent table 210 may be updated with a link (e.g., link 240 or link 241) to the new row (e.g., corresponding row 14 or 15) in the child table 220.
7. If the anchor value retrieved from the row of the parent table is not zero, the anchor value is placed in a hidden column of the new row of child table 220.

This process results in linked list structure 200 connecting rows of child table 220 having the same foreign key values. The foreign key values (i.e, phone numbers in the rows of table 220) are the primary key values of the rows in the parent table 210. The anchor values (such as 240 and 241), of the rows in the Parent Table 210, provide entries to child table 220 from the parent table 210. Each entry in the parent table 210 represents a key value (i.e. a phone number). Thus, a search, by a user to retrieve the calls done by a particular phone number, will locate the anchor in the parent table 210 by the key value (phone number) and follow a linked list to retrieve the rows (in the child table 220) that correspond to the key (e.g., all the rows with the phone number).

For example, in FIG. 2, before the insert of row 15 in child table 220: (i) Row 2 in parent table 210 was connected to Row 12 of child table 220 (by link or anchor value 240), (ii) row 12 of child table 220 was connected to row 3 of child table 220 (by link or connecting value 252), and (iii) row 3 of child table 220 was connected to row 2 of child table 220 (by link or connecting value 251). If process five (above), is then executed: (i) the anchor value (e.g., 12) from parent Row 2 of parent table 210 is retrieved, (ii) link 240 to Row 15 of child table 220 is placed in the anchor value (key value) of the parent ROW 2 of parent table 210, and (iii) the retrieved value (i.e., the existing link value or anchor value (e.g., 12)) is placed in row 15 of child table 220. Further, the placed value in row 15 of child table 220 may connect or link row 15 of child table 220 with row 12 of child table 220 by link 254.

The result of indexing non-primary keys by this process is a linked list (e.g., linked list 200) that connects rows of the same key in a child table. The anchor to the linked list being a row that represents the key value in a parent table. The index structure of the disclosure extends the hash structure of the parent table by a linked list to the rows in the child table.

A query by the non-primary key, using this process, will identify the row in parent table 210 and follow the linked list structure 200 to retrieve the rows in child table that share the same non-primary key (e.g., the same phone number).

The update process of linked list structure 200 described above allows for a faster update process than a B-tree update process, as the linked list process locates rows without needing to examine structures of multiple index blocks prior to the update. In addition, the resources that are considered by the process that updates the non-primary key by linked list 200 are not shared with processes that update a different key value. In contrast, with a B-tree structure, multiple keys may update the same index block and, therefore, some form of synchronization is needed. As a result the B-tree update would be less efficient than an update described by the disclosure.

To provide high insertion rates, inserts are partitioned between the different database nodes (102A-102D) in cluster 110 by a non-primary key. This process is performed such that multiple updates of the same key are executed on the same database node of cluster 110 and therefore the likelihood to find the row (of the parent table that represents the indexed key value) in the local cache of the database node is high. For example, in the call center database of FIG. 2, the inserts of the rows of child table 220 may be partitioned by phone numbers. A proxy (such as proxy 105 in FIG. 1) or an application may determine the database node to use by a formula that assigns a phone number to the database node. As rows with the same phone number may be executed on the same database node, the likelihood to find the row of the parent table 210 in the local cache (e.g., local child table 220) of the database node is high and the update performance would be more efficient than if the parent row is not in the local cache and needs to be retrieved (in order to be updated) by an I/O operation or needs to be transferred to the database node that needs to update the row.

If the inserts of the child table are partitioned by the non-primary key, the update of a second non-primary key may not be well partitioned. For example, the inserts may be partitioned by the phone number from which the call originated, but a second key is defined by the receiving phone number. As multiple rows (with different source phone numbers) in the child table may have the same destination phone number, multiple database nodes may need to update the same key value. This update may trigger complex processes to share and synchronize the row of the parent among the different database nodes.

Therefore, the process of the disclosure may create an independent parent table for every database node in the cluster, for example every database node 101A-101C in FIG. 1. The rows in each parent table may represent the key values of the indexed rows in a child table (e.g., child table 220 in FIG. 2). As a result, there is no need to share and synchronize a row of the parent table among different database nodes. In addition, rows of the parent table, which are frequently used, are locally cached on each corresponding database node. Therefore, the structure of the disclosure may include multiple anchors supporting multiple linked lists for the same key. In a shared data cluster (shared data approach), all the data is available to all the database nodes in the cluster, and therefore, the collection of parent tables is available to all the database nodes in the cluster. A search by the secondary key that is executed on a particular database node: (i) retrieves multiple entries from multiple parent tables, each entry representing the searched key value, and (ii) follows a corresponding linked list from each entry to retrieve rows from the corresponding child table. The collection of rows connected by the one or more multiple linked lists is the data set that satisfies the query.

Thus, the processes of the disclosure can insert and index huge or large amounts of data (big data) with minimal I/O impact. The insert and update of the primary key may be performed by each process to pre-allocated blocks (e.g., pre-assigned blocks for each executing process). Each executing process may add data (e.g., rows of data) to the pre-allocated blocks, and when a block is full, the data may be sent asynchronously to the storage node that is responsible for managing the data block. The non-primary keys may be updated such that the objects representing the keys have a high likelihood of being cached on the local cache of the corresponding database node.

For example, in a cluster with N database nodes, if N independent parent tables are created for each of the N database node, a select process by the non-primary key may follow N linked lists. Each of the N linked lists may be updated by a different node in order to eliminate contention between the nodes.

As the insert of the new data and the update of the primary and non-primary keys are performed with highly efficient processes and minimal contention between processes on the same node or different nodes in the cluster, the database system using the above-described method of the disclosure can update huge amounts/large amounts of data efficiently.

In another example, some queries (e.g., range queries) do need to consider large or huge amounts of data. For example, a query may need to consider all the rows of a table. In some cases, the query may need to examine rows that were generated within some time interval (e.g., a query covering the range of time occurring within the last three years or months).

When these large data sets are considered, the SQL processing may be offloaded from the database nodes to the storage nodes. This process pushes the SQL processing as close to the data as possible and allows for multiple storage nodes to operate in parallel. As each parallel-processing storage node manages a portion of the data, the scan would be more efficient than if a single process considers the entire data set. Pushing the scan to the parallel-processing storage nodes reduces CPU consumption on the database nodes and reduces bandwidth (as only rows that satisfy the queries are transferred to the database nodes from the storage nodes).

To reduce the amount of data scanned on each storage node, each storage node may update local indices (e.g., local parent tables). A secondary indexing process of this disclosure can be used as a local index on a storage node to index rows of a file that are managed by the storage node.

As discussed above and as in many scenarios, a scan may consider a time interval. In these scenarios, each storage node may index the rows of a table by time (data updated with time measurement is sometimes considered as Time Series Data). If the query includes a time predicate, the index directs the process to scan (retrieve) the rows that satisfy the time interval rather than scanning the entire data set.

A secondary indexing process may create an object representing the key value and a link from the object to the indexed row. To index by date-time, and as rows were added to the file by date-time order, it is sufficient to index only the first row for each date-time occurrence. Therefore, when a search needs to consider rows by date-time, the index directs the scan to start from the indexed row and follow the next rows sequentially.

One way to implement this process is to transform date and time entries to a number that represents the time difference in seconds between the first entry in the file (which will be represented by the value zero) and the indexed entry. This number/value may be called a Time Number. The index may be built such that every time number is an entry in a file. This entry in the file may contain the ID of the first row with an indexed time. When a query specifies a time range (e.g., a range of time numbers such as a start time and, optionally, an end time), the start time may be transformed to a time number that is used as a key in the index and the first row with the start time is retrieved. The scan starts at this row and continues (to sequentially retrieve rows or blocks containing rows) until the scan process determines that one or more rows retrieved have date-time entries outside the timeframe (range).

This index may be based on the assumption that the rows inserted to the table are by time order. In the call center example, the rows representing phone calls may be added to the database as they are generated and the indexed column represents the database update time.

Therefore, the secondary indexing process of the disclosure provides indexing by key values and may be executed independently on each of the storage nodes. The process including updating entries on a local structure on each storage node, the entries (represented by key values), maintaining a link, which connects an entry to a row in a data file. The row may contain one or more columns with a key value (e.g., non-unique key) that is represented by the entry on the local structure. A search process may locate the entry in the local structure and follow the link to find the connected row. The search may continue by sequentially scanning data from the linked row or from a location next to the linked row. If the data is partitioned to multiple storage nodes, the process may be executed on multiple storage nodes concurrently and rows that satisfy the query may be sent from each storage node to the database node.

The link from the entry can connect to the row in the data file with the first occurrence of the key value or to one of the rows in the data file with an occurrence of the key value. In the first case, the scan can start from the row. In the second case, the scan process can determine a different location, which is relative to the location of the connected row. The new location may represent a place in the file such that all the rows with the key value can be retrieved by the scan process from the determined location. The new location may be determined by considering the method in which the rows are added to the data file.

Therefore, a process of the disclosure may create a local index by time on a storage node. The local index may be represented by a table (e.g., a local parent table) where entries in the table represent the time and a link from time entries identify a location in the file being searched from which a sequential scan can locate the requested rows.

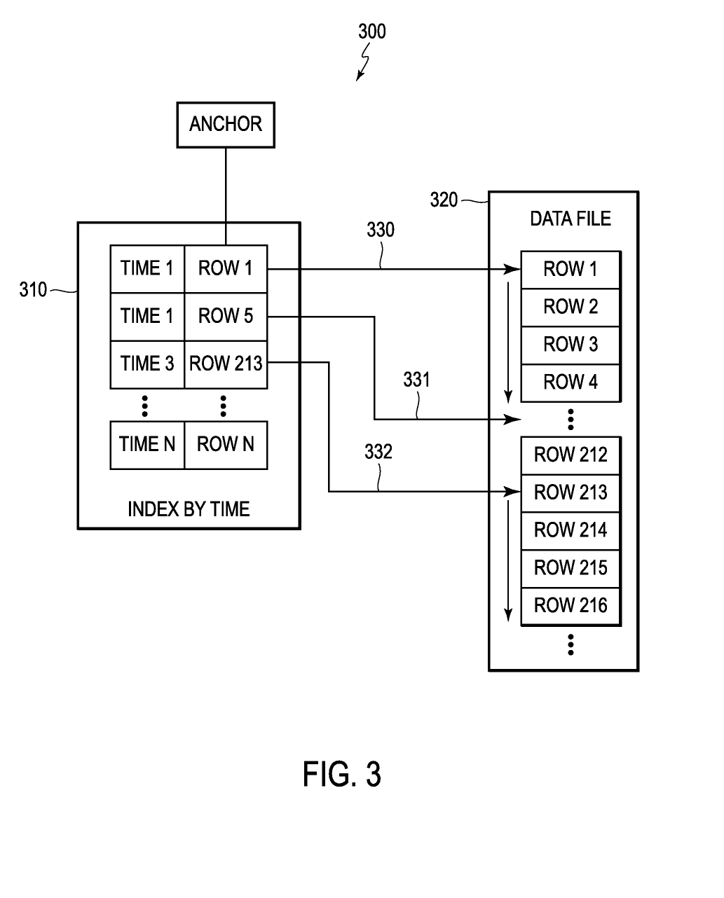

FIG. 3 shows a local index 310 in accordance with a second sub-embodiment of FIG. 1. In particular, in this embodiment, local index 310 may be used on each of storage nodes 102A-102D. An entry in local index 310 may represents a key value (e.g., a time value, a time-date value). Each entry in local index 310 may be connected to a row with a first occurrence of a key value in a data file 320.

For example, FIG. 3 shows a local index 310 on a storage node (e.g., one of storage nodes 102A-102D) that indexes rows in a data file 320. Every entry in the index 310 may be an object representing a time entry (e.g., Time 3 (time entry 3)) that is connected to row 213 of data file 320 connected by link 332). In this embodiment, a scan for time 3 may locate time entry 3 in index 310, and link 332 may direct the scan to start from row 213 of data file 320. As the rows are organized in data file 320 by time, the scan may continue to read rows sequentially and end when the scanning process determines that the all of the rows within the required dates (required date range/timeframe) were considered.

The process of this embodiment is efficient as the index is based on the mapping of the time or date-time entries to physical locations. The contention between threads updating these indices and the number of instructions executed in this process are smaller than a B-tree process. This process can be performed concurrently on multiple storage nodes. As each storage node maintains a portion of the data and therefore processes a portion of the data, this process is much more efficient than a conventional query using a standard index (such as a B-tree) structure. When each of the storage nodes completes the search process, the data is sent to the database node that initiated the query. The database node aggregates the result from all the storage nodes and returns a unified (aggregated) result to the user or application that issued the query.

What is claimed is:

1. A system comprising:
a shared disk database cluster with multiple database nodes, the nodes configured to perform multiple processes, each database node configured to:
insert data to the same table;
assign a unique location for the insert in the same table, the location representing a primary key of a table including an ID of a storage node containing the data; and
update the table without contention with other processes updating the same table.

2. The system of claim 1, wherein each node is further configured to provide a consistent and complete view of the data to a user querying the data.

3. A database method, comprising:
connecting rows that share the same key value, based on a linked list, wherein an anchor of the linked list is from a structure where entries in the structure represent the key values, and
searching for rows by one of the key values; and
retrieving an entry that represents the key value and following the linked list to retrieve the rows.

4. The method of claim 3, wherein, to retrieve all the rows in a table that share the same key, multiple linked lists originating at multiple anchors are considered.

5. A database system, comprising:
one or more database nodes or servers;
one or more storage nodes or servers;
an index structure including entries on a local structure on the storage nodes, the entries representing key values, wherein
entries in the structure maintain a link,
the link connects an entry to a row in a data file,
the row contains one or more columns with the key value which is represented by the entry, and
the one or more storage nodes or servers configured to:
locate the entry in the local structure and follow the link to find the first row, and locating the other rows by sequentially retrieving rows from a location which is relative to the first row.

6. A clustered database system, wherein different database nodes insert new rows to a table, on each database node one or more processes insert rows to the table and update index files, the process on each node is completed without needing to share data with a process on a different node.

7. A database system comprising one or more database nodes, the one or more database nodes configured to:
maintain an index in a storage node such that entries in the index represent a time, and a link that identifies a location in a file; and
sequentially search, using the index, by locating a time entry that identifies an offset in a file from which a scan is initiated.
